(19) United States
(12) Patent Application Publication
(10) Pub. No.: US 2007/0264121 A1
(43) Pub. Date: Nov. 15, 2007

(54) Torsion blade pivot windmill

(76) Inventor: James W. Miller, Bangor, ME (US)

Correspondence Address: GAUTHIER & CONNORS, LLP, 225 FRANKLIN STREET, SUITE 2300, BOSTON, MA, 02110, US

(21) Appl. No.: 11/431,937

(22) Filed: May 10, 2006

(51) Int. Cl. B64C 27/615

(52) U.S. Cl. 416/23

(57) ABSTRACT

A pair of airfoil blades having a longitudinal axis coincident with one another. Each blade is bent at the center on the plane of the chord. Each blade has an airfoil tip blade placed at the outer most trailing edge. The blades are affixed by their root ends to opposite ends of a torsion shaft. The blade chords are offset from one another, which defines a blade pitch angle. The torsion shaft is journaled perpendicular through a driveshaft, whereas the rotation of the blades can transfer through the torsion shaft to the driveshaft and cause the driveshaft to turn, eliminating the need for a hub. The blades are adapted to pivot along with the torsion shaft. The blades lie in substantially the same plane, and are adapted for rotation in a plane orthogonal to the longitudinal axis of the driveshaft. Each blade has an airfoil shaped fluid gate valve disposed on the leading edge.

### BACKGROUND OF THE INVENTION

A windmill, with airfoil blades, must start its motion with the airfoil blades in an aerodynamic stall condition. In order to produce a substantial measure of torque on a windmill airfoil blade, the leading edge of the blade must be looking up wind, the blade chord is placed acutely to the wind face and the longitudinal axes of the blades are arranged to rotate perpendicular to the wind face. Essentially, the wind velocity pressure present on the acute up wind surface of the airfoil blades (side facing up wind) must drive the airfoil blades to a speed sufficient to cause a boundary layer to flow across the down wind cambered surface (side facing down wind) of the airfoil blade with enough force to produce the required dynamic lift force.

Horizontal axis windmills with airfoil type blades, are well suited for use as prime movers in the production of electricity. However, as with all machines, each has its own set of characteristics. Windmills are extremely noisy, especially when operating under heavy loads. Some of the noise associated with windmills indicate the inefficiencies of the machine. For example, blade tip flap or flutter is associated with a wind shear condition, where the wind will shear and flow up from the earth's surface through the rotating windmill blades at acute angles causing a tendency for the blade tips to move back and forth across the plane of rotation. This indicates a difference in the amount of dynamic lift force (torque) produced by each blade as it rotates and passes through the wind shear. The difference in torque causes a fluctuating bending tendency along the longitudinal axes of the blade, and a fluctuating bending tendency to the drive shaft, i.e. a fluctuating yaw tendency to the tower structure. This condition obviously requires the use of thicker, heavier, less efficient blades, and a heavier tower structure, effecting cost, etc.

The wind velocity surface pressure on the up wind sides of the torsion pivot blades, is held at equilibrium from tip to tip across the entire disc of rotation, by means of a free turning torsion shaft and the dynamic torsion coupling effect of the blades interacting with the wind, i.e. there will be zero yaw force, blade flap, and zero bend to the driveshaft.

Windmills with airfoil type blades have a high tip speed ration, and are suitable as prime movers for electric generators, but unless the windmill is placed on an ideal wind site, such as the trade winds of Hawaii, where wind at some locations is almost constant at twenty to thirty M.P.H. (miles per hour), one may find the airfoil blades on their windmill idle a great deal of time.

Energy in the wind is the air particles in motion, (momentum). Anything placed in motion has momentum. The energy (momentum) in the wind can essentially be determined by the number of air particles found in a given space, (density), and how fast the air particles are moving, (velocity).

The wind will cause a pressure against the surface of any solid object placed perpendicular (at right angles) to the wind face, which pressure is referred to as “wind velocity surface pressure” and each time the wind velocity is doubled, the wind velocity pressure will essentially quadruple against the surface of any such object, which surface would be the side of the object looking upwind, (the upwind side).

A typical wind electric generator appropriately placed on a site where if the wind is blowing at a rate of a five miles per hour, (M.P.H.) the airfoil blades would be idle, but if the wind suddenly increased to ten (M.P.H.) the blades will not only spin but will produce electric energy. Whereas if the wind velocity doubles the wind energy will essentially quadruple, (a phenomenon).

The wind interacting with the airfoil blades of a windmill will cause a dynamic lift to the blades, and the blades will start to spin. When the blades are put into motion and gather speed they will gather momentum (energy) and the energy from the spinning blades will turn a driveshaft which driveshaft turns the electric generator. The motion is relative, combining the torque of the spinning blades with the dynamic lift force, which force is caused by the interaction of the blades with the wind.

The motion of the blades is essentially a spinning motion, but the movement is the wind particles where the wind particles will approach the blades, interact with the blades, and move past the blades. The movement is relative.

The spinning airfoil blades of a typical wind generator will rotate through a wind mass in a helical track resembling the threads of a machined screw. Whereas the relative speed of the rotating blades is greater at the blade tip end, than at the blade root end, and the relative blade pitch angle should reflect a helical track which at the time of blade construction would be accomplished by twisting the blade chord at each station of the blade, starting from the blade root end, and extending to the blade tip end.

The relative blade pitch angle is the acute angle at which the blade chord is placed relative to the plane of blade rotation, as seen from the blade tip end.

“The critical angle”, is essentially, where the relative angle of attack becomes so steep to cause the airfoil to lose dynamic lift and the airfoil will stall.

When the relative speed of an airfoil decreases to a certain point, and the blade chord is at a certain relative blade pitch angle, which relative blade pitch angle becomes so steep where the air particles which are moving around the leading edge of the airfoil blade and accelerating in a boundary flow across the downwind cambered side will pull away from the blade surface.

Whereas the boundary flow, when at the correct relative angle (angle of incidence) will cause the rarefaction of air particles on the downwind cambered surface of the blade, which action causes the dynamic lift, but when the boundary flow pulls away form the blade surface, the blade will lose the dynamic lift, and the blade will stall (“critical angle”). In this arrangement, the “angle of incidence” refers to the angle at which the accelerated air particles strike the surface of the down wind side of the blade.

### SUMMARY OF THE INVENTION

Wind generators with airfoil blades are suitable as prime movers for electric generators, but because of the critical angle factor the starting torque is practically zero, and the low end run torque is poor. One reason, as previously described, is the critical angle factor, where the airfoil must start its motion from an aerodynamically stalled condition, and another reason is (i.e.) narrow airfoil blades have less deflection than wide blades, such as water pumpers. Wind generators with airfoil blades work well on ideal wind sites, but not as well on sites where the wind speed is less and the wind will quite often shear and shift direction.

The lift enhancement gate valve will tend to regulate the angle of incidence of the accelerated boundary flow of air across the down wind cambered surface of an air foil blade, thereby enhancing the dynamic lift characteristics of the blade, especially in low to moderate winds. The pivot blade of the subject invention with the lift enhancement gate valve will address the wind shear problem and the critical angle factor.

These and other features and objectives of the present invention will now be described in greater detail with reference to the accompanying drawings, wherein:

### BRIEF DESCRIPTION OF THE DRAWINGS

FIG. 1 is an operational view of the windmill;

FIGS. 2, 3 and 4 are exploded views of the variable pitch torsion shaft assembly;

FIG. 5 is an exploded view of the airfoil pivot blade and airfoil tip blade;

FIG. 6 is a top plan view of the airfoil pivot blade and the airfoil tip blade;

FIG. 7 is plan view showing the upwind surfaces of the airfoil pivot blades and the lift enhancement gate valve;

FIG. 8 is an exploded view of the lift enhancement gate valve.

FIG. 9 is an end view of the lift enhancement gate valve arrangement; and

FIG. 10 is an operational view of the lift enhancement gate valve arrangement attached to section of the air foil rotary blade;

### DETAILED DESCRIPTION OF THE INVENTION

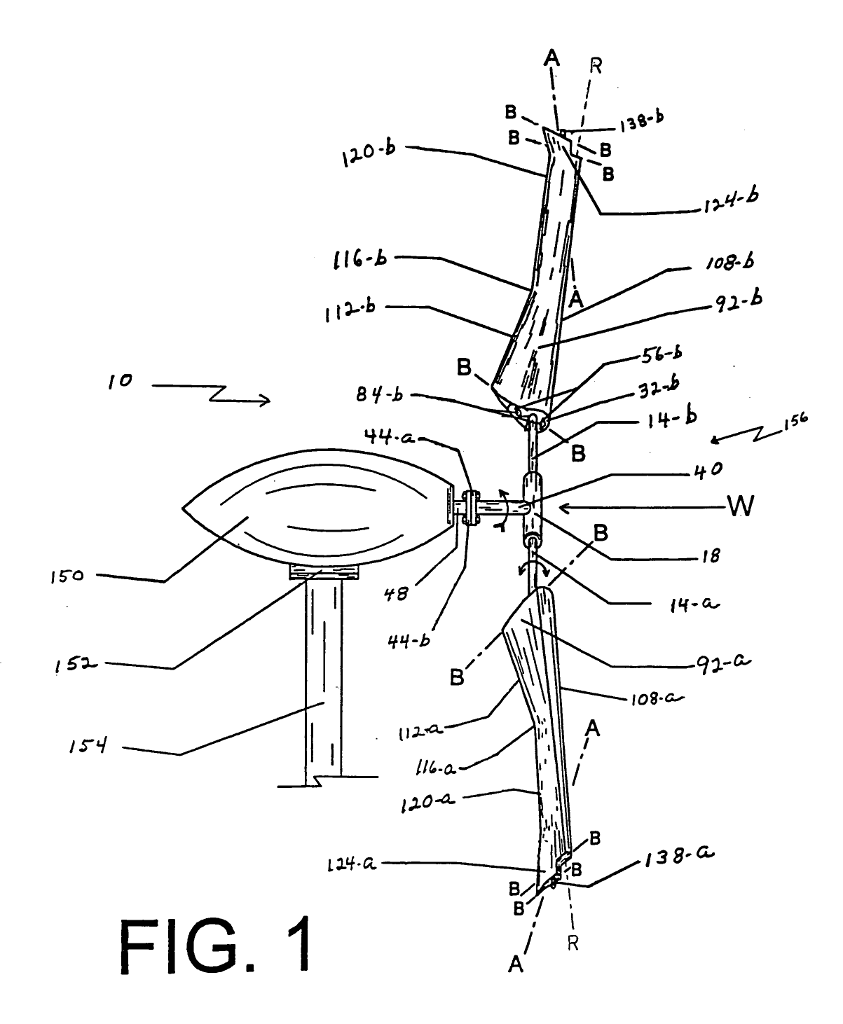

Referring to FIG. 1, when affixed to opposite ends of a free turning torsion shaft, in a certain way, the blade chords will be offset from one another, establishing a blade pitch angle.

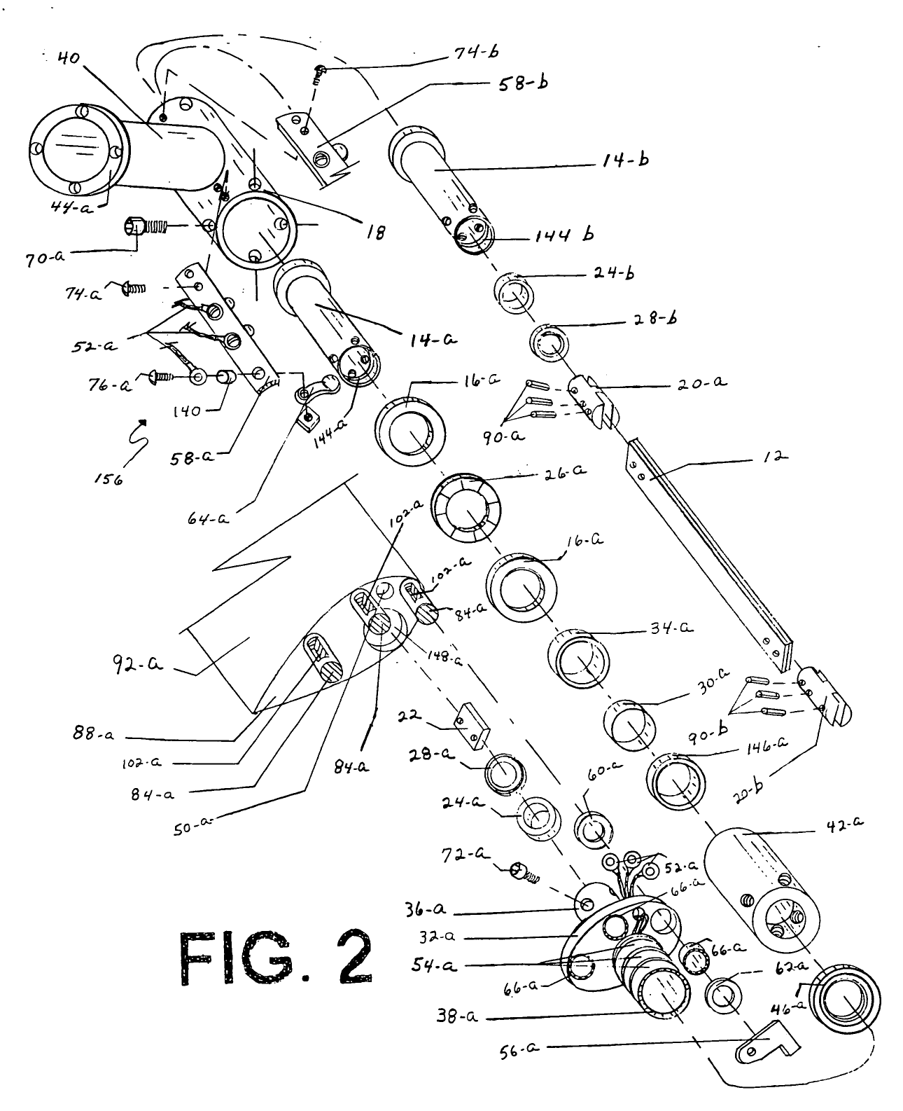

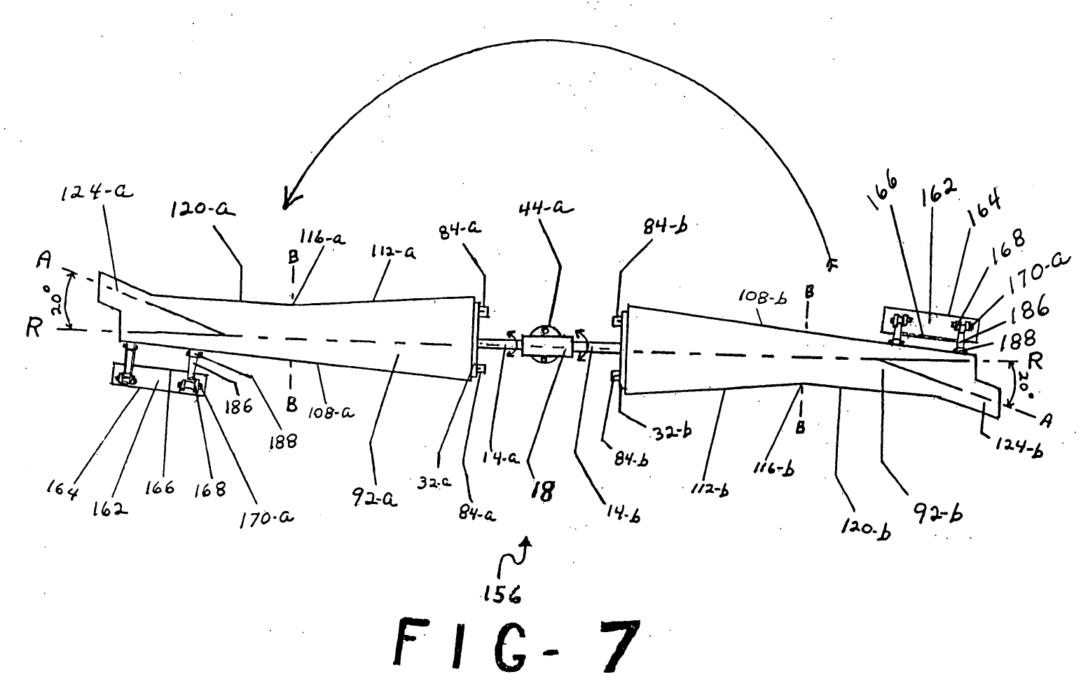

Referring to FIG. 7, airfoil tip blades 124-a, 124-b are placed at the outer most trailing edge section of the airfoil blades 92-a, 92-b, such that the longitudinal axes of airfoil tip blades 124-a, 124-b are placed at acute angles to the longitudinal axis of the torsion shaft, line R-R. Referring to FIGS. 1 and 2, torsion shaft 12 (FIG. 2) is placed in the plane of rotation, such that it will be permitted to simultaneously rotate end over end and turn 360 degrees around its own axis, R-R. (FIG. 1) This arrangement provides a dynamic torsion coupling effect, whereas the wind velocity surface pressure applied to the upwind surface of one airfoil tip blade, 124-a or 124-b, causes the airfoil blades 92-a and 92-b to pivot, and turn the torsion shaft 12, via the shaft sleeves 14-a and 14-b, as shown in FIGS. 1, 2, 3, 4 and 7.

In FIG. 1, when the wind approaches the airfoil blades such that the disc of rotation is at a right angle to the wind, the quantity of surface area seen on the upwind side of airfoil blade 92-a and airfoil tip blade 124-a, is equal to the surface area seen on the upwind side of airfoil blade 92-b and airfoil tip blade 124-b, i.e. the blades rotates, but will not reciprocate (pivot). However, as example, if the wind shears and moves up from the earth surface such that it will approach the disc of rotation at an acute angle, the wind will see a greater quantity of surface area on the airfoil blade 92-a, and airfoil tip blade 124-a. Whereas, the wind velocity surface pressure will be greater on airfoil blade 92-a and airfoil tip blade 124-a, which causes the airfoil blades to pivot, and the blade chords, line B-B, reciprocates as the blades continue to rotate through the wind shear.

Assembly and Operation

Referring to FIG. 2, the torsion shaft sleeves 14-a, 14-b are suspended by the collar thrust against bearings 26-a, 26-b (only one shown) via bearing blocks 42-a, 42-b, which shaft sleeves 14-a, 14-b will all times be free to turn unfettered. The airfoil blades 92-a, 92-b, essentially attach to the shaft sleeves 14-a, 14-b, via the blade root base plates 32-a, 32-b, see FIGS. 2, 3, and 4.

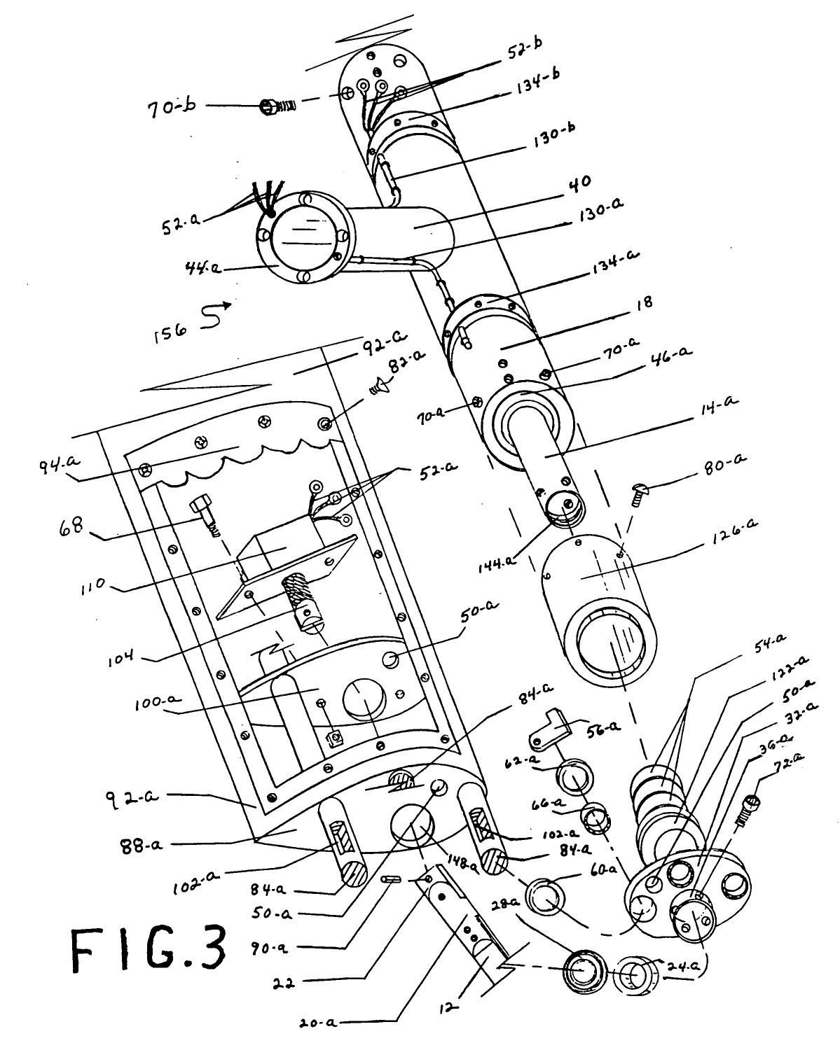

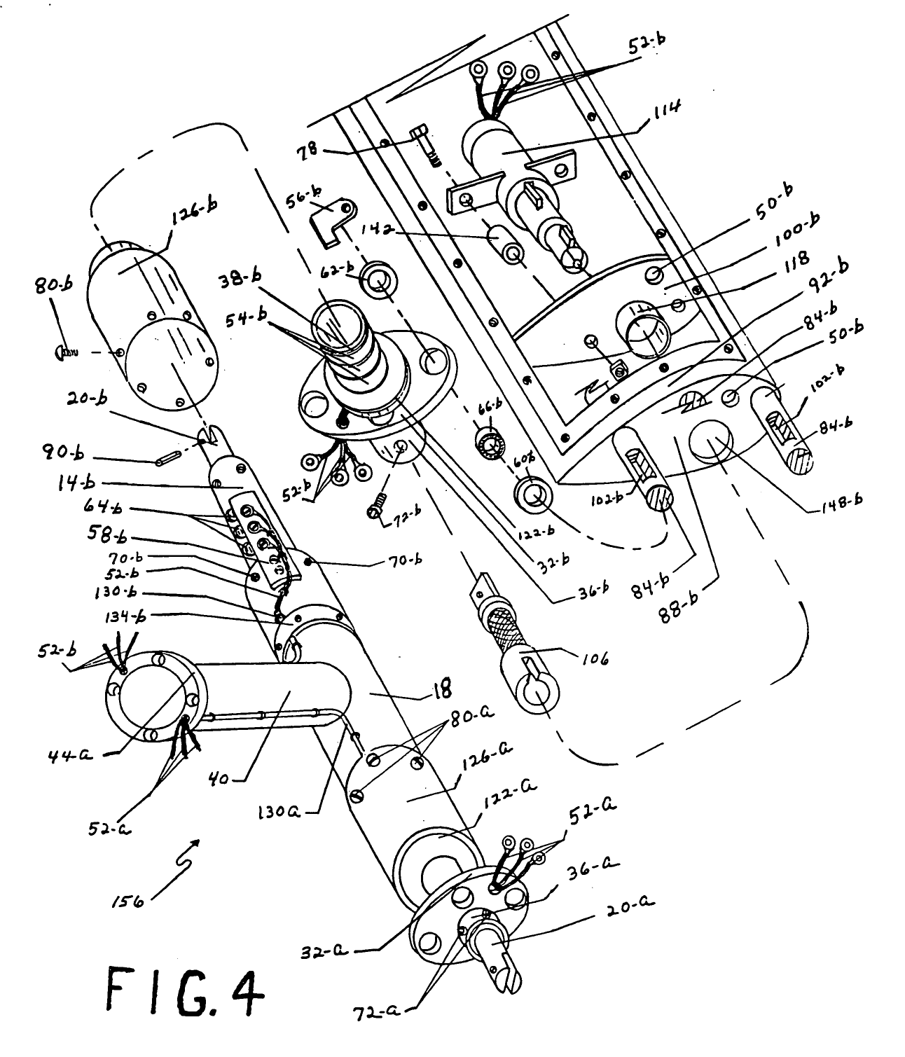

Referring to FIG. 3, the flexible shaft 104 of servo unit 110 fastens to the spring torsion shaft 12, with pin fasteners 90-a, via torsion shaft coupler link 22, and torsion shaft coupler 20-a. The shaft coupler 20-a has a bearing surface which fits and turns inside torsion shaft bearing 24-a. The bearing 24-a press fits into the (seat 144-a) of the torsion shaft sleeve w/collar 14-a and likewise the torsion shaft coupler 20-b, (FIG. 2) has a bearing surface which fits and turns inside torsion shaft bearing 24-b, which bearing 24-b, press fits into the seat 144-b of torsion shaft sleeve w/collar 14-b. The spring torsion shaft 12, (FIGS. 2 and 3) fastens at one end, at servo unit 110 with coupler link 22 and pin fastener 90-a. The other end of the spring torsion shaft 12, (FIG. 4) couples to the spring loaded keyed shaft of the coupler solenoid 114 via the slotted torsion shaft flexible coupler 106 at airfoil blade 92-b w/pin fastener 90-b.

To simplify the drawings of FIGS. 3 and 4, (exploded views) only one torsion shaft sleeve bearing block 42 is shown in FIG. 2. Torsion shaft sleeve bearing block 42-b and related like parts, is not shown, but are identical and will assemble in the same fashion as torsion shaft sleeve bearing block 42-a.

Referring to FIG. 3, this view shows the torsion shaft sleeve w/collar 14-a, which sleeve 14-a is placed inside the torsion shaft sleeve bearing block 42-a, which sleeve bearing block 42-a is placed inside the torsion shaft housing sleeve 18. Only two of four screw fasteners 70-a are shown. The screw fastens 70-a fastens the torsion shaft sleeve bearing block 42-a to the torsion shaft housing sleeve 18.

Referring to FIG. 4, there are two of four screw fasteners 70-b shown, which screw fasteners 70-b, fasten the sleeve bearing block 42-b, into place, which sleeve bearing block 42-b, and related bearing slide fit over the torsion shaft sleeve w/collar 14-b, and the collars of both, torsion shaft sleeve w/collar 14-a and 14-b, can butt against one another inside torsion shaft housing sleeve 18. The face surface of the collars of shaft sleeves 14-a and 14-b are low friction, such as Teflon, i.e. if the windmill 10, (FIG. 1) has an emergency shutdown, where the coupler solenoid 114 (FIG. 4) uncouples the airfoil blades 92-a, 92-b, from one another, via the spring torsion shaft 12, and if the computer has parked the airfoil blades 92-a, 92-b, such that their longitudinal axis are placed in the vertical plane, the wind vane effect, where, the wind velocity pressure acting on the surface of the airfoil tip blades 124-a, 124-b (torsion lever effect) can turn the blades 92-a, 92-b, to the feather.

When the windmill blades are in operation, the collars of shaft sleeves 14-a, 14-b are thrust against the sleeve bearing blocks 42-a, and 42-b, via the related bearings, and there is a small space between the related collar butt surfaces, of less than one eighth of one inch.

Referring to FIG. 3, the view showing, torsion shaft sleeve w/collar 14-a, assembled with sleeve bearing block 42-a, which bearing block 42-a is fastened inside the housing sleeve 18, which screw fasteners 70-a (two of four shown). The sleeve seal 46-a seals the related bearings from the outside. The torsion shaft bearing 24-a press fits against the bearing seat 144-a, the bearing seal 28-a seals the bearings 24-a.

Referring to FIGS. 2, 3, and 4, the electrical brush block 58-a, which fastens to the torsion shaft housing sleeve 18 by using screw fasteners 74-a (only one shown) is the manner in which the shielded electrical wiring 52-a attaches to the electrical brush 64-a with screw fasteners 76-a, and stand-off spacer sleeve 140. For the purpose of illustration, the shape and number of electrical brushes 64-a and 64-b, and electrical slip rings 54-a, 54-b are identical, however, it should be understood that, the number of electrical slip rings, brushes and necessary wiring can vary as may be required, but the general shape and manner of attachment will remain the same.

The view in FIG. 4, shows the electrical conduit 130-b, the rain tight seal 134-b, the shielded wiring 52-b, the electrical brushes 64-b, and the electrical brush block 58-b, which brush block 58-b is attached to the torsion shaft housing sleeve 18, using screw fasteners 74-b. The rain tight electrical brush cover sleeve 126-b, slide over the rain tight seal 134-b and up on to the shaft housing sleeve 18, such that the electrical brushes 64-b is accessible. The blade root base plate 32-b, the rain tight electrical brush cover w/lip 122-b, and non conductive electrical slip ring stem 38-b fastens to the blade root base plate stem 36-a. The electrical slip rings 54-b attaches in typical fashion to the electrical slip ring stem 38-b. The shielded electrical wiring 52-b fastens in a typical manner to the electrical slip ring 54-b, which shielded electrical wiring 52-b, then passes through the chase 50-b in the blade root base plate 32-b. The electrical brushes 64-b, have a typical spring characteristic. The blade root base plate stem 36-b will light drive fit over the protruding end of the torsion shaft sleeve w/collar 14-b, and a tool is used to lift the electrical brushes 64-b, such that the electrical slip rings 54-b slide beneath the electrical brushes 64-b. The blade root base plate stem 36-b attaches to torsion shaft sleeve w/collar 14-b, with screw fasteners 72-b (only one shown). When the tool is removed from the electrical brushes 64-b, the spring action causes the electrical brushes 64-b to press against the electrical slip rings 54-b i.e. to make electrical contact.

The small end of the rain tight electrical brush cover sleeve 126-b is plastic coated and slide fits around the rain tight electrical brush cover w/lip 122-b, and butts the over hang portion of the lip. The large end of the rain tight electrical brush cover sleeve 126-b fastens to the torsion shaft housing sleeve 18, at the rain tight seal 134-b, with screw fasteners 80-b (only one shown). Compare like parts rain tight electrical brush cover sleeve 126-a, 126-b and brush cover w/lip 122-a, 122-b. This arrangement permits the torsion shaft sleeves w/collar 14-a, and 14-b to turn freely inside the rain tight brush cover sleeves 126-a and 126-b.

In FIG. 2, the leaf springs of the spring torsion shaft 12, fasten to the torsion shaft couplers 20-a, and 20-b with pin fasteners 90-a and 90-b and simply slides through the centers of sleeves 14-a and 14-b, as is shown in FIG. 2 and FIG. 4, via the torsion shaft bearings 24-a and 24-b. Referring to FIGS. 2 and 3, the three spars 84-a of the airfoil blade 92-a, attaches to the blade root base plate 32-a, in such a way that the protruding end of the blade root base plate stem 36-a extends into the root rib aperture 148-a of the blade root base rib 88-a. Only one of the three spars 84-a is shown along with the necessary parts to demonstrate how the airfoil blade 92-a fastens, the two other spars 84-a, uses like parts, and fastens in the same manner. Such that the spar shim plates 60-a slide fits over the protruding end of blade spar 84-a. The elastic blade spar shock sleeves 66-a, are constructed of metal bands and elastic, which blade spar shock sleeves 66-a press fits into the spar sleeves 86-a, of blade root base plate 32-a. The blade spars 84-a tight slide fits through the shock mount sleeves 66-a, blade spar shim plate 62-a slide fits over the end of the blade spars 84-a and the blade and the blade spar retaining pins 56-a, drive fits through the blade spar retainer pin slots 102-a, such that the blade root base rib 88-a are drawn tight against the blade spar shim plates 60-a.

Airfoil blade 92-b, uses like parts, which parts are used with airfoil blade 92-a, airfoil blade 92-b attaches and fastens in the same manner as that which was described for airfoil blade 92-a.

The access panel cover 94-a, FIG. 3, is self explanatory, it attaches using screw fasteners 82-a. The servo unit 110 attaches to the blade rib bulkhead 100-a with screw fasteners 68 (only one shown). The shielded wiring 52-a attached to the servo unit 110, passes through the wiring chase 50-a in the blade rib bulkhead 100-a. The shielded wiring 52-a attached to the electrical slip rings 54-a is shown in FIG. 4, which wiring passes through the wiring chase 50-a in the blade root base plate 32-a and the wiring chase 50-a in the blade root base rib 88-a, where the electrical joints are made inside the airfoil blade 92-a.

The torsion shaft coupler link 22, via the root rib aperture 148-a, fastens the flexible shaft 104 of the servo unit 110 to the torsion shaft coupler 20-a with pin fasteners 90-a, i.e. the spring torsion shaft 12, is fastened at one end only, which is to the airfoil blade 92-a via the housing of the servo unit 110.

The end of spring torsion shaft 12, FIGS. 2 and 4, which attaches to the shaft coupler 20-b, which shaft coupler 20-b attaches to the torsion shaft flexible coupler 106 with pin fasteners 90-b, via the aperture 148-b of the blade root base rib 88-b (FIG. 4). The slotted end of the torsion shaft flexible coupler 106, loose slide fits into the torsion shaft flexible coupler guide sleeve 118, which guide sleeve 118, can be constructed using spun glass reinforced nylon, and attached to the blade rib bulkhead 100-b with epoxy resins. The purpose of the coupler guide sleeve 118 is to provide a means of support for the slotted end of the torsion shaft flexible coupler 106, in such a way as to effect the alignment of the keyed shaft of the coupler solenoid 114, and the key-way slot of the flexible coupler 106. The coupler solenoid 114 attaches to the blade rib bulkhead 100-b with screw fasteners 78 and standoff spacer sleeves 142 (only one of each shown), such that the small end of the keyed shaft of the coupler solenoid 114, extends far enough into the shaft guide sleeve 118 to effect a coupling with the torsion shaft flexible coupler 106.

The coupler solenoid 114, as constructed, has a typical electrical wiring scheme, FIG. 4, a keyway slot in the solenoid housing and a key in the shaft, which key permits the shaft to slide into, and out of the solenoid housing, but will not permit the shaft to turn. The end of the shaft of the coupler solenoid 114 has a shaft key and is machined to a smaller diameter than that of the shaft which diameter permits the shaft to loose slide fit into the end of the torsion shaft flexible coupler 106, and when coupled the key and slot arrangement prevents the shaft from turning.

FIG. 4, the shaft of the coupler solenoid 114, is spring loaded such that when the solenoid electrical winding is de-energized, the shaft is thrusted against a stop inside the solenoid housing, which causes the shaft to extend from the housing, i.e. The spring pressure on the coupler solenoid shaft 114, permits the servo unit 110, to turn the flexible coupler 106 such that when the key of the coupler solenoid shaft 114 finds the key way slot of the flexible coupler 106, the torsion shaft 12, effectively couples together the airfoil blades 92-a and 92-b, and the relative position of the blade chords will be the same each time the blades are coupled.

The coupler solenoid 114 has a typical centrifugal switch arrangement, (not shown) where basically, a measured weight is placed against a spring tension such, that when the spinning weight reaches a certain gravity force, which gravity force causes the spinning weight to over ride the spring tension, i.e. actuating the electrical switch.

The electrical wiring 52-b is the shielded electrical wiring for the coupler solenoid 114, which solenoid 114 is attached to the airfoil blade 92-b, as previously described. The shielded wiring 52-b is like the shielded wiring 52-a, which wiring 52-a was previously described for the servo unit 110, which servo unit 110 is attached to the airfoil blade 92-a. The wiring 52-a and 52-b, has like parts, electrical slip rings 54-a and 54-b, electrical brushes 64-a and 64-b, electrical conduit 130-a and 130-b, electrical wiring chase 50-a and 50-b, which chase is through like parts, blade rib bulk heads 100-a and 100-b, blade root base ribs 88-a and 88-b, blade root base plates 32-a and 32-b. The wiring 52-a and 52-b attaches in the manner as previously described.

As shown in FIG. 1, the windmill driveshaft axle 48, has a flange 44-b which flange 44-b, is like the flange 44-a, but slides over the end, and on to the driveshaft axle 48, such that when the flange 44-b is welded to the driveshaft axle 48, the end portion of the driveshaft axle 48, extends beyond the face of the flange 44-b, which end portion of the driveshaft axle 48 machine to an outside diameter, which diameter, matches the machined inside diameter of the driveshaft housing sleeve 40, which housing sleeve 40, has a welded flange 44-a. The driveshaft housing sleeve 40, slide fits over the machined end of the driveshaft axle 48, such that the flange 44-a attaches to the like flange 44-b in a typical fashion with dowel fastener (not shown) and bolts.

The shielded wiring 52-a, 52-b (shown in FIG. 4) passes through conduit 130-a, 130-b, the driveshaft housing flange 44-a, and the like flange 44-b, (FIG. 1) attach in typical fashion to an electrical slip ring arrangement (not shown), and are placed on the driveshaft axle 48 inside the nacelle 150. The typical electrical arrangement attaches the necessary wiring to the electric switches and computer controls, are located inside the windmill nacelle 150, (not shown). The computer and electric switched controls the electric current flow to the servo unit 110, (shown in FIG. 3) and the uncoupler solenoid 114.

FIGS. 1, 2, 3 and 4, the computer (not shown) and the servo unit 110, via the spring torsion shaft 12, control the relative blade pitch angle, (the relative acute angle at which the blade chords are presented inclined to the wind,) which relative blade pitch angle is seen as lines drawn from B-B in FIG. 1. As previously described, the housing of the servo unit 110, is attached to the airfoil blade 92-a, the flexible shaft 104 of the servo unit 110, is attached to the spring torsion shaft 12, such that when the servo unit is electrically energized the magnetic torque from the servo motor causes the housing of the servo unit 110, to move (turn) in one direction, and cause the flexible shaft 104, to turn in the opposite direction from that of the servo unit housing.

FIGS. 1, 2, 3 and 4, the spring torsion shaft 12, extends through the shaft assembly, 156, and attach to the airfoil blade 92-b via the uncoupler solenoid 114. The airfoil blades 92-a, 92-b, are attached to the free turning torsion shaft sleeves 14-a, 14-b, i.e. The computer may cause the airfoil blades 92-a, 92-b, to turn such that the blade chords B-B in FIG. 1, can turn in opposite directions from one another 360 degrees around the axis R-R, which effects the relative blade pitch angle from zero degrees to the feather position. This arrangement (as previously described) will also allow the longitudinal axis of spring torsion shaft 12, to turn end over end in the plane of rotation with the airfoil blades 92-a, 92-b, The airfoil blades 92-a, 92-b rotate perpendicular to the windface, and around the driveshaft axle 48, i.e. the spring torsion shaft 12, can turn inside the torsion shaft sleeves w/collar 14-a, 14-b and can simultaneously reciprocate with the torsion shaft sleeves w/collar 14-a, 14-b, via slip rings 54-a and electrical brush, 64-a (FIGS. 2, 3, and 4).

As previously described, the torsion shaft sleeves w/collar 14-a, 14-b, along with the attached blades 92-a, 92-b, the servo unit 110, the spring torsion shaft 12, coupling links, and coupler solenoid 114, are free to turn around the axis R-R, i.e. when the airfoil blades 92-a, 92-b, are uncoupled from one another, the blade chords B-B are aligned with the wind and the airfoil tip blades 124-a, 124-b, are aligned downwind, such that, the airfoil tip blades 124-a, 124-b, will have a wind vain effect, which keeps the blade chords B-B aligned with the wind, (the feather position). i.e. It would not be necessary to turn the windmill into the wind, until the storm has passed and the prevailing wind returned.

The dynamic torsion coupling effect is restored when the windmill 10, is turned into the wind and the airfoil blades 92-a, 92-b are turned such that the blade chords B-B are placed at acute angles to one another, where the surfaces on the upwind side of the airfoil blades 92-a, 92-b, are inclined to the wind face.

In an emergency condition, the coupler solenoid 114, as previously described, is a means for effectively uncoupling the airfoil blades 92-a, 92-b from one another, and shutting the windmill down. The solenoid 114 uncouples via the motion switch (not shown), when a catastrophe, causes the tower to shake. A runaway blade is a condition where the blade can rotate at a speed beyond the design limits of the blade. As an example, where the load to the windmill driveshaft is suddenly lost, the computer would normally sense the condition, adjust the relative blade pitch angle and or shut the windmill down. However, if the computer fails, the centrifugal switch, located in the coupler solenoid, will, as previously described uncouple the blades from one another and shut the windmill down. When the airfoil blades 92-a, 92-b are uncoupled from one another, and a break applied to the driveshaft 48, FIG. 1, the wind vain effect as previously described causes the blades to turn to the feather position.

A windmill which is in operation and generating electricity, will typically experience routine subtle load shifts to the blades, where a sudden change in power demand or a sudden gust in wind velocity, causes the relative load to fluctuate. The flexible shaft 104 (FIGS. 3 and 4), of the servo unit 110, the flexible shaft coupler 106, and the blade spar elastic shock sleeves 66-a and 66-b, are arranged such as to permit the airfoil blades 92-a, 92-b, to flex, such that the elastic shock sleeves 66-a, 66-b permits the blades 92-a, 92-b, to bend down wind by an amount which will effectively handle the shock of most routine load shifts.

In a catastrophic load shift condition, such as previously described, the spring torsion shaft 12, FIGS. 2 and 3, permits the blades to twist toward the feather position, which action releases wind velocity pressure i.e. avoiding blade shear at the point of attachment. This arrangement permits the spring torsion shaft 12 to have enough spring resilience (to be stout enough) to control the relative blade pitch angle, and permits the blades to pivot and reciprocate, without oscillating, so that this arrangement permits the spring torsion shaft 12, to respond to the extreme catastrophic load shifts and permits the elastic shock sleeves 66-a, 66-b, to respond to routine load shifts.

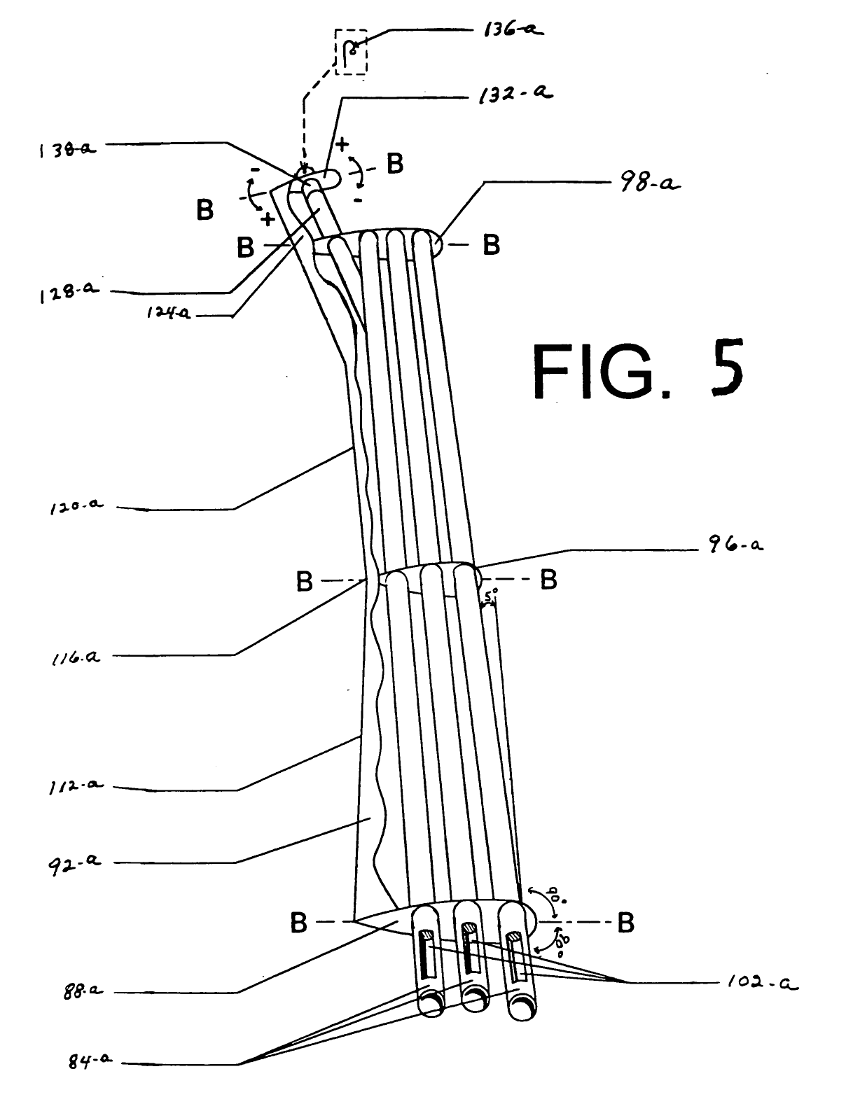

For the purpose of illustration, FIG. 5 shows a scheme for constructing the airfoil blade 92-a, using ribs and spars. The airfoil blade 92-b would be an exact duplicate of the airfoil blade 92-a, using like parts.

The blade spars 84-a are equal in diameter, and have an appropriate taper from root to tip.

The blade spars 84-a can be constructed in a typical fashion, using composite fibers and a laminated hardwood core, which core extends through the blade root base rib 88-a and the blade rib bulkhead 100-a (FIG. 3). A stainless steel sleeve can be placed over and bonded to the protruding ends of the blade spars 84-a.

The slots 102-a in the protruding end of the blade spars 84-a provide a means of attaching the blade using the retaining pin 56-a. (FIGS. 2, 3 and 4).

The blade leading edge spar 84-a have a slight bend at the point where the blade spar 84-a passes through the blade root base rib 88-a, which bend is (for this demonstration), (FIG. 5) shown at the five degree acute angle. The angle is shown at the leading edge of the root base rib 88-a and the leading edge blade spar 84-a. The blade ribs 96 and 98 are placed parallel to the blade root base rib 88-a.

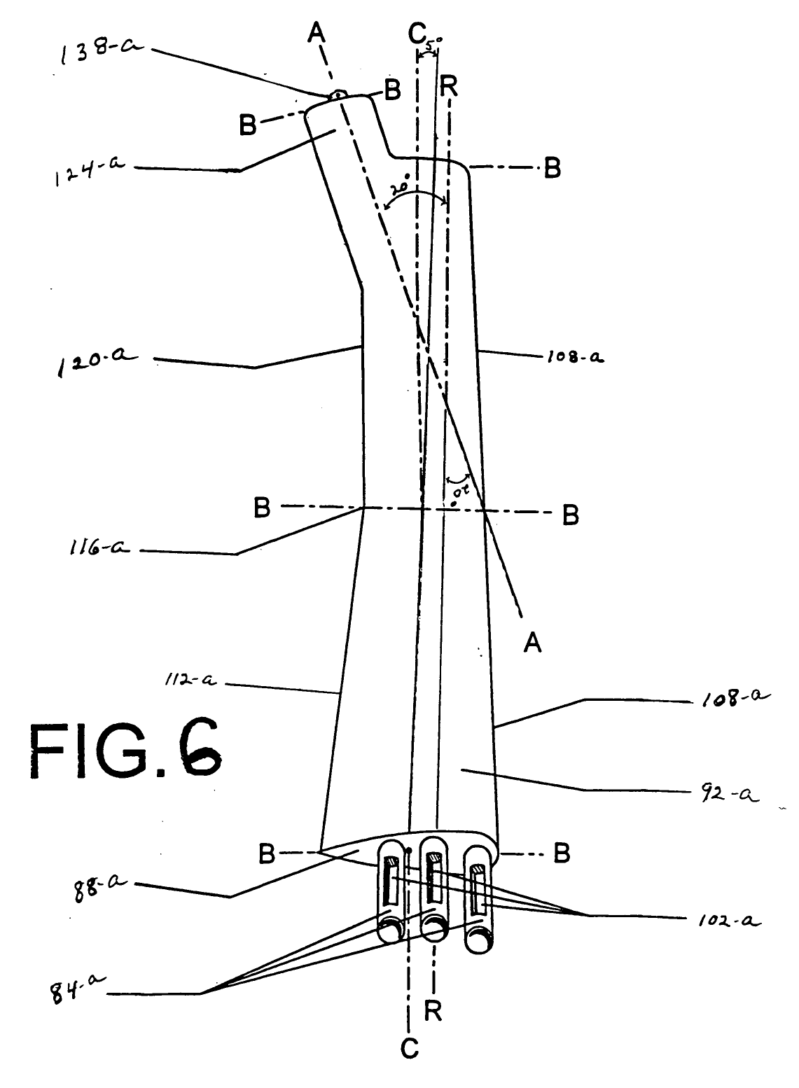

Referring to FIGS. 5 and 6, the portion of the blade trailing edge 112-a (root to center), which trailing edge 112-a is arranged such that it extends from the root base rib 88-a, to the trailing edge center 116-a, and moves toward the blade leading edge 108-b, which arrangement causes the blade width from the root end to its center to appear to the wind as having a uniform taper. The blade trailing edge 120-a, which trailing edge 120-a bends at the trailing edge center 116-a, such that the trailing edge 120-a is placed parallel to the blade leading edge 108-a. This arrangement causes the airfoil blade 92-a to bend at its center. (FIG. 6) For this illustration, the acute angle of the bend is five degrees, as shown by the line drawn from C-C. The line which is drawn perpendicular to the root base rib 88-a, line B-B, converges with the line C-C, at the blades center. The line drawn from A-A, represents the longitudinal axis of the airfoil tip blade 124-a. The axis A-A is shown placed at an acute angle of 20 degrees to the line drawn from R-R, which line R-R represents the longitudinal axis of the spring torsion shaft 12. The torsion shaft 12, is placed in the plane of rotation. It should be understood that the airfoil blade 92-a and 124-a, shown in FIG. 6, could be molded in one piece construction scheme, using composite materials.

This arrangement, when placed at opposite ends of the torsion shaft, as previously described, establishes a dynamic lever torsion coupling, which lever torsion coupling allows the blades to pivot, in such a way as to establish an equalization of wind velocity pressure on the blade surfaces.

The airfoil tip blade 124-a is constructed of materials such as graphite and glass fiber. The tip blade rib 132-a (FIG. 5) is bonded to a sleeve 138-a, which sleeve 138-a is placed over the end of the spar 128-a, which sleeve 138-a can turn around the spar 128-a. Corresponding holes are drilled through the sleeve 138-a and the spar 128-a, the retainer pin 136-a is placed through the holes, such as to prevent the sleeves 138-a from turning. The composite fiber covering of the airfoil tip blades 124-a, and 124-b has a resilience, which permits twisting a few degrees, without effecting the structural integrity. This arrangement permits the airfoil tip blades 124-a and 124-b to twist by a few degrees.

The purpose for this arrangement is to provide a simple means of adjusting the dynamic twist to the blade chord, (fine tuning).

Assembly

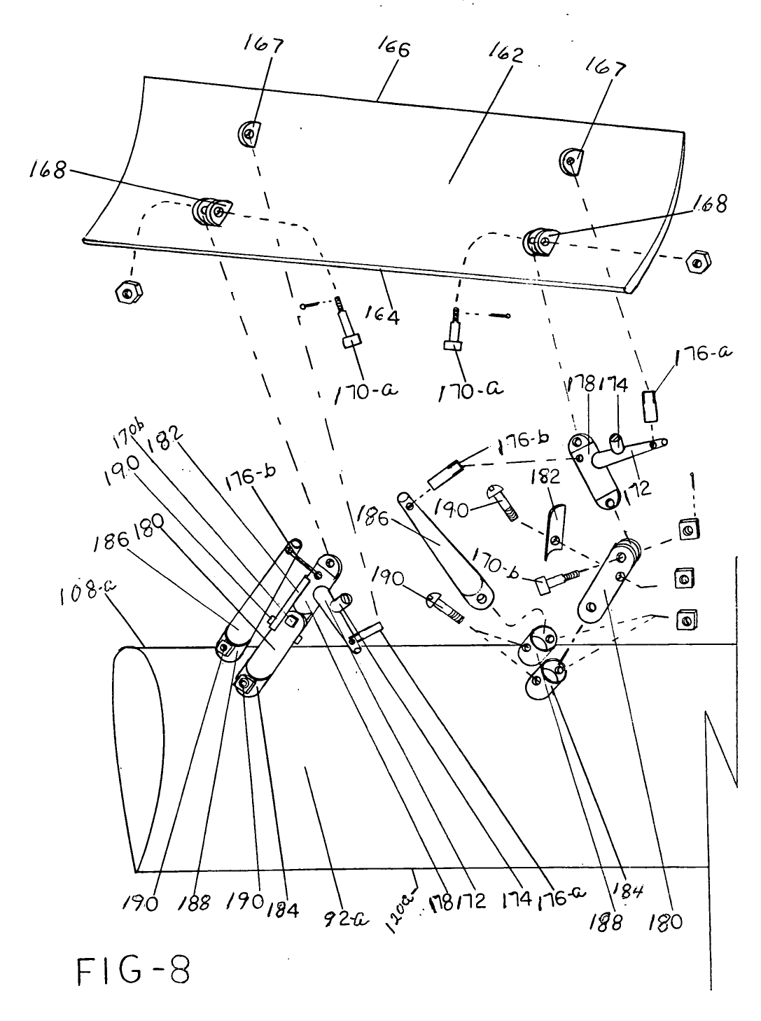

Ref. to FIG. 8, for the purpose of identifying the individual parts of the lift enhancement gate valve shown in the exploded view, the number 162 represents the gate valve blade, 164, is the gate valve blade leading edge, 166, is the gate valve trailing edge, 167, is one of two coupling tabs, 168, is one of two gate valve blade hinges, 170a is one of the two hinge pins, 170b is one of two hinge pins, 172, is one of two gate valve blade spring rods, 174, is one of two gate valve blade stops, 176a is one of two spring rod coupling links, 176b is one of two spring rod coupling links, 178, is one of two hinge links, 180, is one of two hinge link posts, 182 is one of two hinge link stops, 184 is one of two hinge link post base, 186 is one of two hinge link spring rods, 188 is one of two hinge link spring rod base, 92a is the airfoil blade, 108a is the airfoil blade leading edge, 120a is the airfoil blade trailing edge.

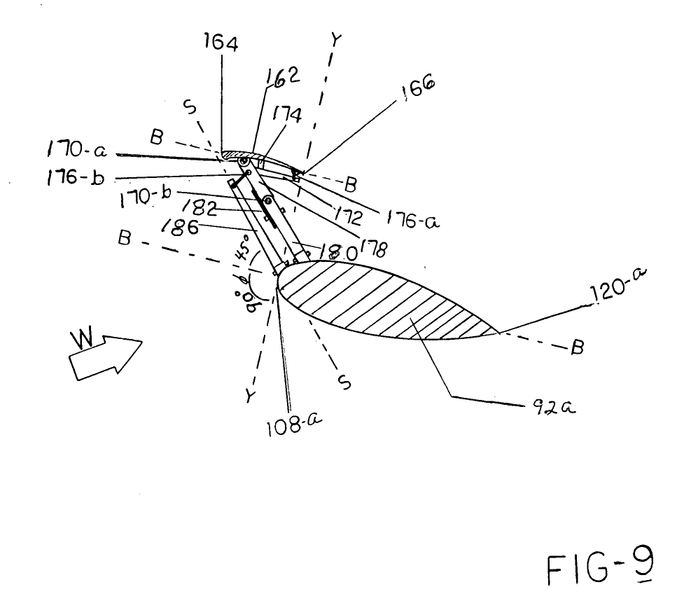

The lift enhancement gate valve shown in FIG. 9, represents an end view of the valve at rest, where the respective chord lines (B-B) are parallel to one another, the hinge link 178 rests against the hinge link stop 182, the gate valve blade 162, rests against valve blade stop 174. The line drawn from B-B represents the respective chords of the blades, the line S-S represents the longitudinal axis of hinge link spring rod 186, and the line Y-Y (at right angle to line B-B) represents the line at which the trailing edge of gate valve blade 162 is places relative to the leading edge of the airfoil blade 92a.

Ref. to FIGS. 8, 9, 10 for the purpose of illustration, (FIG. 8) the width of gate valve blade 162, can be between ten and twenty percent the width of airfoil blade 92a. The dish shaped surface on the upwind side of gate valve blade 162, reflects the downwind cambered surface at the nose of airfoil blade 92a. Hinge link 178 can measure in length, a distance equal to twenty five to thirty percent the length of hinge link post 180. Hinge link spring rod 186 (FIG. 9), and hinge link post 180, are placed such that the axis S-S is at a forty five degree angle, relative to the blade chords B-B.

In FIG. 8, it should be understood, for the purpose of illustration only one gate valve is shown, the other valve (not shown) will have like parts and functions in a like manner.

With reference to FIG. 7, for the purpose of illustration, the view shown would be the blade surface area seen at right angles to the wind, (the upwind side of the blades), consider the leading edge 108a/108b, and the chord (B-B) the surface of the upwind side of the blades should be inclined at an acute angle to the wind. The angle would be relative to the chord (B-B) and the plane of rotation, (blade pitch angle). The blades would rotate in the direction indicated by the arrow drawn around the driveshaft 48, (not shown).

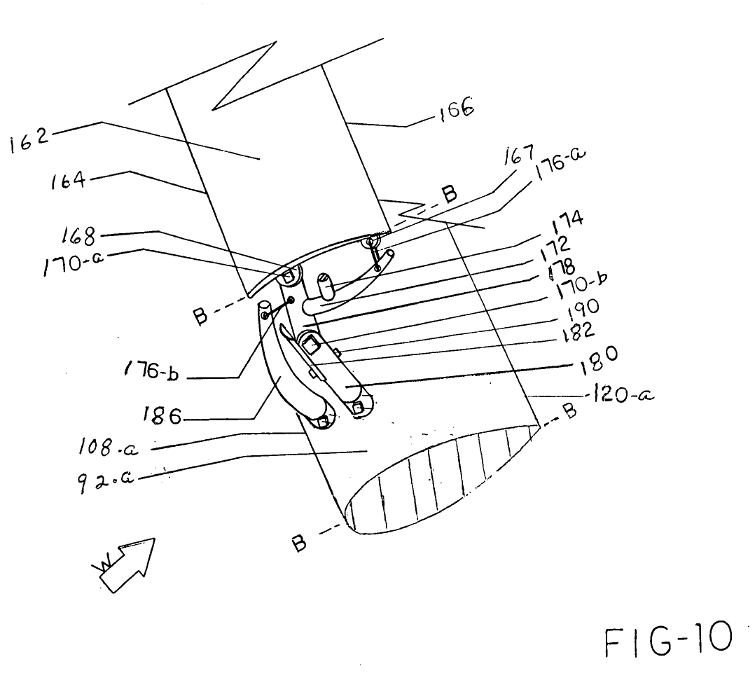

As shown in. FIGS. 9 and 10, the space (as seen by the wind) between the trailing edge 166, of gate valve blade 162, and leading edge 108a of airfoil 92a establishes a “fluid gate” through which air can flow. The wind velocity surface pressure acting on the upwind side of the airfoil, will be equal to the velocity surface pressure acting on the upwind side of gate valve blade 162. The wind velocity pressure causes stress to the air particles on the upwind side of the “fluid gate” in such a way to cause a force. The force which is placed against the upwind surface of gate valve blade 162, tends to open the gate, and cause a tension to the valve blade spring rod 172, and hinge link spring rod 186. The tension is progressive and causes a progressive elastic effect, (similar to the air particles escaping from a balloon) and causes the escaping air particles to increase acceleration across the down wind cambered surface of airfoil blade 92a, which effects the rarefaction factor.

As shown in FIGS. 9 and 10, when the relative speed of the airfoil blade 92a increases, the relative wind velocity pressure increases at the upwind side of the “fluid gate”, and the stress placed on the air particles at the upwind side of the “fluid gate”, will essentially place a progressive force (tension) against the valve blade spring rods 172, via the upwind surface of gate valve blade 162. The force causes the gate valve blade 162, to swing on valve blade hinges 168, and hinge pins 170a, and causes hinge links 178 to swing on hinge pins 170b at hinge link posts 180, in such a way as to cause spring rods 186 to bend, via the spring rod coupling links 176b. This causes hinge link 178 to swing on hinge pin 170b, such that the trailing edge 166 of gate valve blade 162 tends to move in an arc toward the surface of airfoil blade 92a, which movement tends to close the “fluid gate”, however, as the relative wind velocity pressure progressively increases at the upwind side of the “fluid gate”, it causes a progressive wind velocity pressure on the upwind surface of gate valve 162. The pressure tends to open the “fluid gate”, and causes the valve blade spring rods 172 and hinge link spring rods 186 to bend in such a way as to cause a progressive tension to the air particles. The progressive tension causes the escaping air particles to accelerate. The arrangement causes a progressive accelerated boundary flow of air across the downwind cambered surface of airfoil blade 92a, and directs the escaping accelerated air particles to strike the surface of the downwind side of the blade 92-a at the appropriate ‘angle of incidence’ such as to ca use the optimal dynamic lift enhancement.

When the wind velocity pressure acting on the upwind side of gate valve blade 162 (FIG. 10) reaches a certain force the leading edge 164 of gate valve blade 162 moves toward the trailing edge 120a of airfoil blade 92a, and will essentially aligns both chord lines B-B (FIGS. 9 & 10) with one another and the chord of gate valve blade 162 (FIG. 10) is aligned with the boundary flow, such that the dynamic drag to gate valve blade 162 will be minimal (lift to drag ratio).

It should be understood that the torsion pivot blades can function by using a one piece spring or rigid torsion shaft, which torsion shaft would journal perpendicular through a driveshaft, would be free to pivot, and the blades would be affixed to opposite ends of the torsion shaft, such that the blade chords would be in an offset relationship to one another, (a fixed blade pitch angle) and to have a means to couple and uncouple the blades from one another;

This arrangement would function well for smaller wind electric battery chargers, but the variable pitch blades (w/lift enhancement gate value), provide other applications, such as large electric wind generators and hovercraft.

While various examples and embodiments of the present invention have been shown and described, it should be appreciated by those skilled in the art that the spirit and scope of the present invention are not limited to the specific description and drawings herein, but extend to various modifications and changes.

I now claim:

1. A wind powered engine comprising:
a variable pitch torsion shaft assembly, a horizontal drive shaft, a pair of airfoil blades, and a fluid gate valve;
each airfoil blade having a chord line drawn substantially through the center of the blades and extending from a leading edge to a trailing edge, each blade having a twist to the chord, each airfoil blade having a longitudinal axis extending from root end to tip end of the blade, each airfoil blade is bent at its center on the plane of the chords;
each blade having an airfoil shaped fluid gate valve disposed on the leading edge, which fluid gate valve acts to enhance the rarified air on the surface of the downwind cambered side of the airfoil blades;
each blade being joined by a blade section at the outer trailing edge end, which blade section terminates in an airfoil tip blade, the longitudinal axes of the airfoil tip blades are placed at acute angles relative to the longitudinal axes of the airfoil blades and the longitudinal axis of the variable pitch torsion shaft assembly;
the variable pitch torsion shaft is journaled perpendicular through the drive shaft, and the airfoil blades are affixed by the root ends to opposite ends of the variable pitch torsion shaft so that the blade chords are placed in an offset relationship to one another and establishes a variable blade pitch angle,
the longitudinal axes of the airfoil blades are placed in line with the longitudinal axis of the variable pitch torsion shaft;
which arrangement allows the longitudinal axes of the blades and the longitudinal axis of the variable pitch torsion shaft to rotate together in a plane which is orthogonal to the longitudinal axis of the driveshaft, whereas the variable pitch torsion shaft assembly rotates end over end and can change the relative blade pitch angle of the blades as the blades rotate;
the acute angle at which the longitudinal axes of the tip blades are placed, relative to the longitudinal axes of the blades and the longitudinal axis of the variable pitch torsion shaft causes the axes of the airfoil tip blades to act as dynamic torsion lever arms;
whereas when the wind engages the blades, a wind velocity surface pressure develops on the upwind side of the blades and applies a force along the longitudinal axes of the blades and along the longitudinal axis of the tip blades, which tip blades enhance the dynamic force on the trailing edge tip section of the blade, essentially acting as torsion lever arms which are coupled via the root end of the blades to opposite ends of the variable pitch torsion shaft, which torsion shaft along with the blades is free to pivot as it rotates end over end in a plane orthogonal to the longitudinal axis of the drive shaft;
whereas the rotation of the spinning airfoil blades can transfer to the driveshaft via the variable pitch torsion shaft, essentially eliminating the need for a hub;

2. The wind powered engine of claim 1, including the wind velocity surface pressure acting on a pair of rotary airfoil blades which blades are rotating in a wind shear condition;
whereby when the wind contacts the leading edge of the airfoil blades, the fluid gate valve regulates the boundary flow of air across the cambered surface on the downwind side of the blades, and the wind velocity surface pressure acting on the upwind side of the blades are held at equilibrium (by the lever pivot action) from blade tip to blade tip across the entire disc of rotation;

3. The pivoting action of the blade chords reciprocate together as the blades rotate through a wind shear, eliminating drive shaft bending and blade flap;
